(19) United States
(12) Patent Application Publication
(10) Pub. No.: US 2004/0083423 A1
(43) Pub. Date: Apr. 29, 2004

(54) Adaptation of multimedia contents

(75) Inventor: Do Nyun Kim, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 10/685,808

(22) Filed: Oct. 16, 2003

(30) Foreign Application Priority Data
Oct. 17, 2002 (KR) 2002/63564

(51) Int. Cl. G06F 17/00

(52) U.S. Cl. 715/500.1

(57) ABSTRACT

There is provided a method for generating a DID instance document of a digital item. A “ChoicePrecedence” descriptor is used to perform an adaptation of an original DID instance document, a recently adapted DID instance document and a newly adapted DID instance document. Designated precedence (first, second, third, last, preemptive, delete) or a “BaseChoice” and attributes (reset, before, reorder) are used to adaptively modify the recently adapted DID instance document into the newly adapted DID instance document. Alternatively, the recently adapted DID instance document is created with reference to the original DID instance document and then adaptively modified into the newly adapted DID instance document.

### BACKGROUND OF THE INVENTION

1. Field of the Invention

The present invention relates to a digital item adaptation, particularly to an adaptation method of DID instance document using a “ChoicePrecedence” descriptor of a digital item and a method of generating the “ChoicePrecedence” descriptor of the digital item.

2. Description of the Related Art

In activities related to an electronic commerce, such as creation, production, transaction, transmission, management, storage and consumption of multimedia data, there have been demands for flexible, transparent and augmented use of multimedia resources.

Specifically, considering a tendency to widely use an electronic commerce with an advance of Internet, a non-existence of a declaration model for the treatment unit of the multimedia data used in the electronic commerce is a latent factor that may cause a confusion of the electronic commerce.

In consideration of these points, a declaration of the digital item is stipulated in MPEG-21 of an international standard organization ISO/IEC SC29/WG11, maximally taking consideration into users of an electronic commerce business model (the users includes all subjects related to the electronic commerce, such as digital item creator, provider, distributor, consumer, intellectual property right holder, financial service provider, electronic commerce supervisor, and the like) . There has been an attempt to make the digital item to be an international standard that is flexible, coherent and compatible on the basis of relationship between the subjects of the electronic commerce or their associated descriptions.

Accordingly, there have been demands for a declaration model of the digital item, which can consider relationship between the subjects (or users) of business model configuration in the electronic commerce or the associated descriptions and achieve the electronic commerce without regard to kinds of networks or terminals.

The declaration model of such a digital item should have a compatibility, a coherence and a flexibility as a minimum unit of multimedia data in the activities of the electronic commerce, such as creation, production, transaction, transmission, management, storage and consumption of the multimedia data used for the electronic commerce.

The digital item is a fundamental unit of whole activities, such as creation, production, transaction, transmission, management, storage and consumption of the multimedia contents that are valuable as an intellectual property under wired/wireless environments. Generally, the digital item consists of three components. In other words, the digital item can include: a RESOURCE (for example, movie or music itself) which is an individual asset or content; a DESCRIPTOR (for example, title of movie or music, genre, name of author, summary of contents, usage conditions, or regulation of the contents) describing the contents and their usages; and configurational elements (for example, “CHOICE”, “SELECTION” and “CONDITION”) configuring the digital item.

In addition to the resource itself, the digital item can further include metadata. The metadata contains a DESCRIPTOR describing the resource, a SELECTION element that can be selected by the user, a CHOICE element that is a bundle of SELECTION elements, and each of the SELECTION element and the CHOICE element contains a CONDITION element that represents validity under a specific condition. Additionally, the digital item includes many COMPONENTS (an actual resource (music file or graphic file) and a DESCRIPTOR). Among them, in order to make it possible for the user to select desired COMPONENT and configure suitable digital item, the digital item and the COMPONENT contain the CONDITION element that requires a specific condition set by the user. Specifically, the CONDITION refers to the SELECTION element. If there exist a SELECTION element chosen by the user in the reference list, the corresponding CONDITION is “true”, and if not, it is “false”.

As described above, the CHOICE element describes a set of related SELECTION elements, and the CONDITION element describes pre-satisfied conditions.

Digital items can be reconfigured to generate new digital items (composite digital items).

For example, image digital items are configured to generate a composite digital item, which is called an album. In that case, each of the image digital items is an external storage digital item existing in an independent storage unit. In order to contain the image digital items, the new album digital item contains REFERENCES that are accessible to them.

Additionally, in case the desired digital items are configured using the CONDITION elements, an efficient representation of the CONDITION is an important factor that determines an efficiency of comparative operation and a capability to represent the CONDITION. There is a demand for an efficient representation of the CONDITION, which considers characteristics of condition comparison objects.

The digital item is described with a DECLARATION, a CONTAINER and an ITEM in a Digital Item Declaration Language (DIDL).

A COMPONENT includes a RESOURCE such as audio, video, graphic and text, an ANCHOR indicating the RESOURCE, and a DESCRIPTOR describing the COMPONENT. An ITEM is grouping of sub-ITEMS and/or COMPONENTS. Also, a CONTAINER is a structure that allows ITEMS and/or CONTAINERS to be grouped. The digital item can include other digital items, and a reference component accessible to an external storage digital item is defined in the digital item.

The digital item shows a mechanism that can select desired configuration using the CHOICE element and the SELECTION element. Additionally, the user can configure desired digital item by using the CONDITION element. An efficient representation of the CONDITION is an important factor that determines an efficiency of comparative operation and a capability to represent the CONDITION. Accordingly, it can be seen that there is a demand for an efficient representation of the CONDITION, which considers characteristics of a condition comparison object.

As described above, it is necessary to provide a description that can make the user experience various multimedia contents in the most optimum state according to various usage environments. In other words, it is necessary to provide a description that can make the user experience the multimedia in the most optimum state according to a capability of user terminal, a capability of network, a capability of a delivery layer, a user characteristic such as preference and gender, a natural environment characteristic, and a capability of provided service. For the purpose of these descriptions, a Digital Item Adaptation (DIA) should basically provide a descriptor on the usage environment.

On the basis of the requirements, various usage environment descriptors should be described or processed to cope with the tendency that various multimedia contents are provided and usage environments of the contents are extensively varied. Accordingly, there is a demand for a method of generating a descriptor that defines which environment descriptor is preferred among various and mass environment descriptors in the digital item adaptation.

MPEG-21 standard for a multimedia framework declares a digital item as a basic unit of multimedia contents, and the multimedia contents are represented by a DID instance document which is described in a Digital Item Declaration Language (DIDL) declaring the digital item. The DID instance document includes information on a digital item configuration and employs a user configuration selector, which is called a CHOICE. Accordingly, a digital item adaptation of the MPEG-21 should include DID instance document adaptation.

Additionally, in order to adapt the DID instance document, there is a demand for an adaptation method of the CHOICE element to be used in the digital item configuration. Further, there is also a demand for a “ChoicePrecedence” descriptor to be applied to the CHOICE.

### SUMMARY OF THE INVENTION

An object of the present invention is to solve at least the above problems and/or disadvantages and to provide at least the advantages described hereinafter.

It is another object of the present invention to provide an adaptation method of multimedia contents, using various user terminal capacity, network capacity, user preference, and the like, in activities such as retrieval, transaction, transmission, management and consumption of the multimedia contents.

It is another object of the present invention to provide an adaptation method of a “ChoicePrecedence” descriptor that substantially obviates one or more problems due to limitations and disadvantages of the related art.

It is another object of the present invention to provide an adaptation method of DID instance document using a “ChoicePrecedence” descriptor and a method of generating the “ChoicePrecedence” descriptor in an adaptation of multimedia contents using various user terminal capacity, network capacity, user preference, and the like, in activities such as retrieval, transaction, transmission, management and consumption of the multimedia contents.

It is another object of the present invention to provide an adaptation method of a “ChoicePrecedence” descriptor and a method of generating the “ChoicePrecedence” descriptor, in which DID instance document with DID configuration function is adaptively generated using usage environment precedence so as to provide best multimedia to various users having various demands under various environment.

According to an embodiment of the present invention, in a description of multimedia contents based on usage environment descriptor and user preference descriptor of the multimedia contents, an adaptation method of generating a digital item declaration document is characterized in that a “ChoicePrecedence” is applied to an input DID instance document to modify a corresponding “ChoicePrecedence” of the input DID instance document in an order designated in the “ChoicePrecedence”, and to generate a rearranged DID instance document.

According to another embodiment of the present invention, in a description of multimedia contents based on usage environment descriptor and user preference descriptor of the multimedia contents, a method of generating a “ChoicePrecedence” descriptor is characterized in that the “ChoicePrecedence” descriptor is generated by describing a “TargetChoice” of a digital item, a condition if necessary, and a “ChoicePrecedenceClass”, the “ChoicePrecedenceClass” being described by a “SpecifiedPrecedence” or a “BaseChoice”.

Additional advantages, objects, and features of the invention will be set forth in part in the description which follows and in part will become apparent to those who have ordinary skills in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings, in which like reference numerals refer to like elements wherein:

FIG. 1 is a flowchart shows an adaptation of DID instance document according to a preferred embodiment the present invention;

FIGS. 2 and 3 illustrate adaptations of the DID instance document according to a preferred embodiment of the present invention;

FIGS. 4 to 6 illustrate attribute usages according to a preferred embodiment of the present invention;

FIG. 7 illustrates a generation of a “ChoicePrecedence” descriptor according to a preferred embodiment of the present invention; and

FIG. 8 illustrates a structure of DIAinDID description.

### DETAILED DESCRIPTION OF THE PREFERRED EMBODIMENTS

Preferred embodiments of the present invention will now be described, examples of which are illustrated in the accompanying drawings. Wherever possible, the same reference numerals will be used throughout the drawings to refer to the same or like parts.

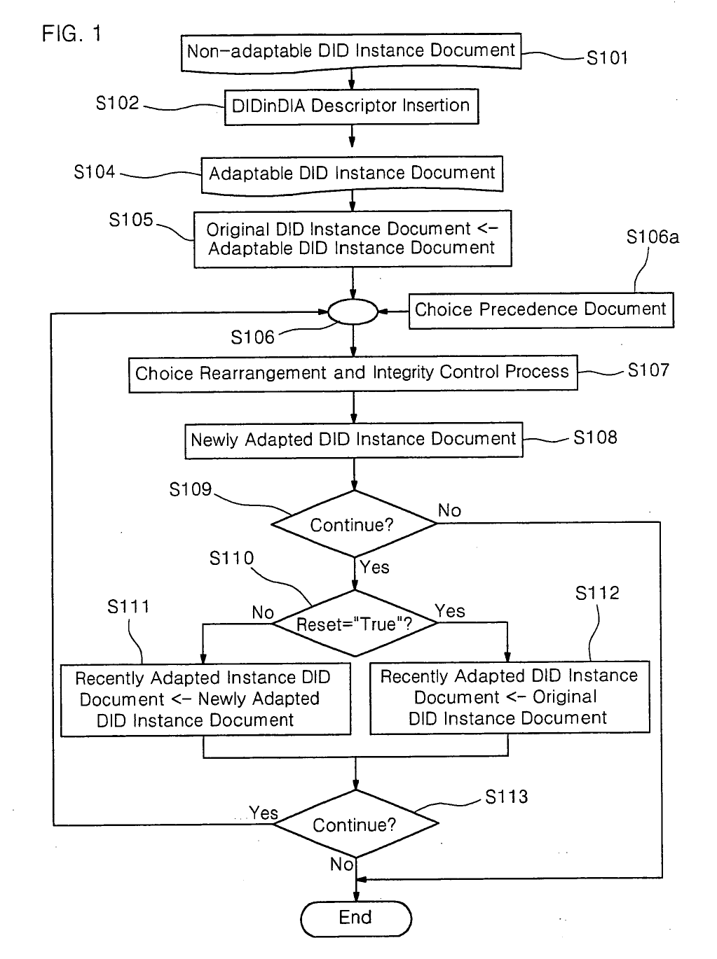

Hereinafter, an adaptive generation method of DID instance document and a “ChoicePrecedence” descriptor used therein will be described in detail with reference to FIGS. 1 to 8.

FIG. 1 is a flowchart shows an adaptation of DID instance document according to the present invention. The adaptation method of the DID instance document according to the present invention applies to three documents and is based on an adaptation using an attribute suitable for a “ChoicePrecedence” descriptor.

Referring to FIG. 1, the adaptation method of the present invention includes the steps S101 to S105 of modifying the DID instance document into an adaptable format, the steps S106 to S108 of reconfiguring the “ChoicePrecedence” by applying a “ChoicePrecedence” document, and the steps S109 to S113 of generating an adapted DID instance document by applying attribute.

In order for the adaptation of the DID instance document, the DID instance document should be modified into the adaptable format. Three different documents exist so as to adapt the DID instance document. One of them is an original DID instance document that is a DID instance document modified into the adaptable format at an initial step. Another is a recently adapted DID instance document that is the most recently adapted result. The other is a newly adapted DID instance document that is a newly adapted result.

For example, if a “ChoicePrecedence” is applied one time to the original DID instance document that is an adaptable document initially generated, the original DID instance document becomes the newly adapted DID instance document. Then, if a “ChoicePrecedence” is applied once more, the newly adapted DID instance document becomes the recently adapted DID instance document. The document created newly at this step becomes the newly adapted DID instance document.

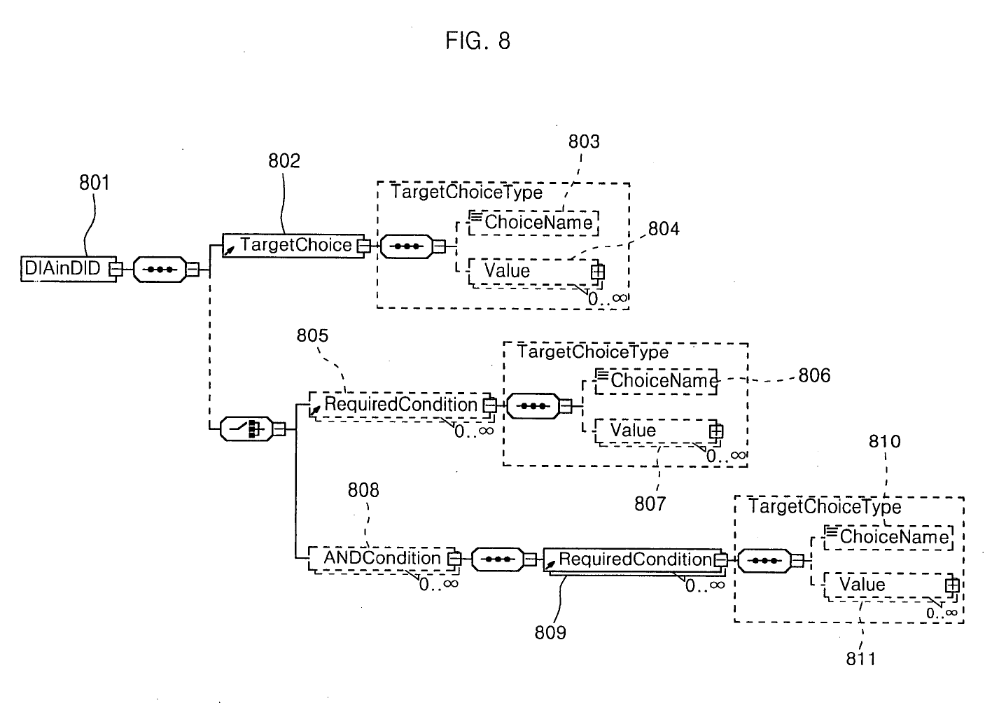

Herein, a description of the steps S101 to S105 will be made. First, non-adaptable DID instance document is prepared (S101). A DIAinDID (Digital Item Adaptation in Digital Item Declaration) descriptor is inserted into the non-adaptable DID instance document (S102). In other words, the DIAinDID descriptor of FIG. 8 is inserted into the DID instance document so as to modify the DID instance document into the adaptable format. As shown in FIG. 8, the DIAinDID descriptor 801 is a descriptor representing a corresponding CHOICE and defined by a “TargetChoice” 802 and a portion describing choice conditions 805 and 808.

In other words, FIG. 8 shows the DIAinDID descriptor that is inserted into the non-adaptable plain DID instance document to generate the adaptable DID instance document. The DIAinDID descriptor includes a portion describing the “TargetChoice” and a portion describing the conditions in case they exist. The “TargetChoice” 802 is described by a “TargetChoice” type and includes a “ChoiceName” (environmental variable such as a screen size) 803 and a corresponding “Value” 804. A “RequiredCondition” 805 includes a “ChoiceName” 806 and a corresponding “Value” 807, and an “ANDCondition” 808 includes a “RequiredCondition” 809. The “RequiredCondition” 809 also includes a “ChoiceName” 810 and a corresponding “Value” 811.

If the DIAinDID descriptor of FIG. 8 is inserted into the choice to be adapted, the DID instance document is modified into the adaptable DID instance document and the adaptable DID instance document is stored in the original DID instance document (S104, S105).

At the following steps, the DID instance document is modified by a user configuration preference, i.e., a “ChoicePrecedence”, with respect to the original DID instance document. A “ChoicePrecedence” document S106a is applied (S106), and a choice rearrangement and integrity control process is carried out based on the “ChoicePrecedence” to generate a modified DID instance document (S107). The modified DID instance document is then stored in the newly adapted DID instance document(S108).

Here, the integrity control process is carried out so as to ensure the integrity of the DID instance document. In other words, if the choice is rearranged or deleted due to the “ChoicePrecedence”, other choices referring to the adapted choice are affected. For example, if the choice related to the screen size is deleted due to the “ChoicePrecedence”, the choice having the “RequiredCondition” of the screen size should be deleted. Therefore, in order to ensure the integrity of this DID instance document, the integrity control process is carried out.

Then, it is determined whether or not there is more “ChoicePrecedence” to be processed (S109). If there is no more “ChoicePrecedence”, the process is ended. If a new “ChoicePrecedence” adjusting requirement is inputted, a “reset” attribute is examined (S110). If the “reset” attribute is “true”, the DID instance document is reset to the original DID instance document generated by inserting the DID instance document into the DIAinDID descriptor at the initial steps (S112).

It is determined whether or not there is more “ChoicePrecedence” to be processed (S113). If there is no more “ChoicePrecedence”, the process is ended. If there is more “ChoicePrecedence” to be processed, the process proceeds to the step S106 and the following steps S108 to S113 are repeatedly carried out according to new “ChoicePrecedence”.

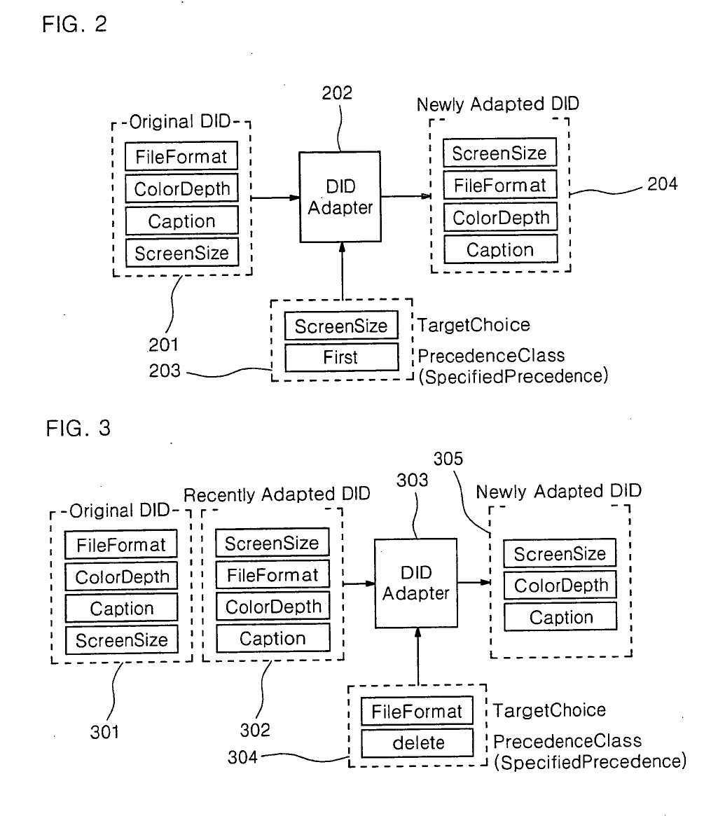

The adaptation method of the DID instance document described above will be described with reference to FIGS. 2 to 6. The adaptation method of the present invention is based on three documents (the “original DID instance document”, the “recently adapted DID instance document” and the “newly adapted DID instance document”), and appropriate attributes (“reset”, “reorder”) can be used therein. There is an example showing the adaptation of the DID instance document in case the “TargetChoice” class includes a file format, a color depth, a caption and a screen size.

In FIG. 2, there is shown a case that a choice related to a screen size is first configured when there is no document adapted just before in an original DID instance document that is an adaptable DID instance document.

Specifically, there is provided a DID adapter 202 for an original DID instance document 201. In case that a user request 203 sets the screen size to a first precedence, a newly adapted DID instance document 204 is generated by a DID adaptation of the DID adapter 202. In case a “TargetChoice” set by the user is the “ScreenSize” and a precedence set according to the “PrecedenceClass” is the “First” precedence, the rearranged result of the original DID instance document 201 is the newly adapted DID instance document 204 in which the screen size is placed the top of the document.

Referring to FIG. 3 showing a next step of FIG. 2, the DID instance document 204 stored as the newly adapted DID instance document is then stored as the recently adapted DID instance document 302 (here, there is the original DID instance document 301 as it is). If a new user configuration preference, i.e., a “ChoicePrecedence” request 304, is inputted (in FIG. 3, the request is to delete the file format), the DID adapter 303 is not applied to the original DID instance document like FIG. 2, but the user request is applied to the recently adapted DID instance document 302, thereby generating a newly adapted DID instance document 305 in which the file format is deleted.

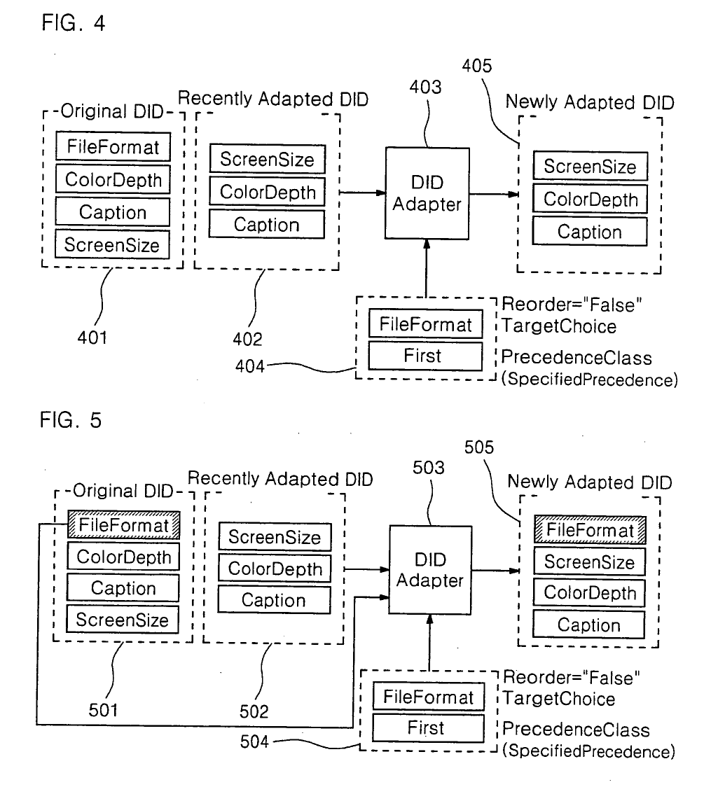

FIGS. 4 and 5 are views illustrating attributes of the “reorder”. If the attribute of the “reorder” is “true”, a “ChoicePrecedence” requested only within the recently adapted DID instance document is processed.

In FIG. 4, there are provided an original DID instance document 401, a recently adapted DID instance document 402, a DID adapter 403 and a newly adapted DID instance document. If a choice of the file format does not exist in the recently adapted DID instance document 402 and the “reorder” is set to “true”, this means that only reordering is performed. Therefore, in this case, the newly adapted DID instance document 405 newly adapted by the DID adapter 403 is not modified.

In FIG. 5, there are provided an original DID instance document 501, a recently adapted DID instance document 502, a DID adapter 503, a user request 504, and a newly adapted DID instance document 505. Referring to FIG. 5, if the “reorder” is not set (that is, “reorder”=“false”), the DID adapter 503 generates the newly adapted DID instance document 505 with reference to the original DID instance document 501 in case that there is a request (the file format in FIG. 5) for a choice that does not exist in the recently adapted DID instance document 502). In other words, the file format of the original DID instance document 501 is inserted to generate the newly adapted DID instance document 505 in which the file format is placed at the top of the document.

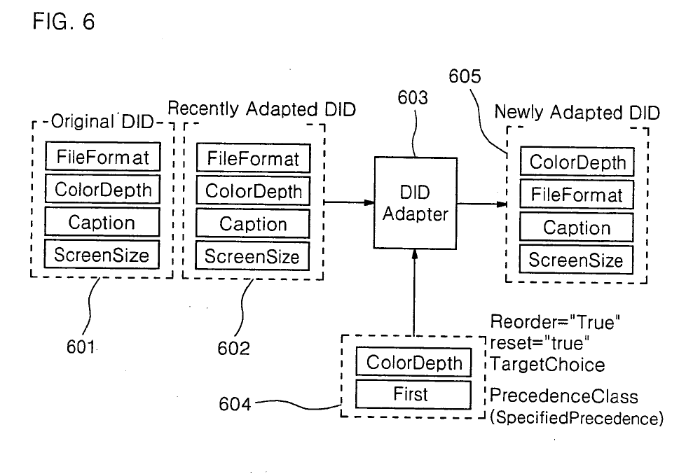

FIG. 6 illustrates a structure of the DID instance document adaptation according to the attribute of the “reset”. If the attribute of the “reset” is “true”, the newly adapted DID instance document that is generated with the recently adapted DID instance document is not stored, but the original DID instance document is stored. In other words, the process of returning to the initial state of the “ChoicePrecedence” is carried out. In FIG. 6, there is provided the original DID instance document 601, the recently adapted DID instance document 602, the DID adapter 603, the user request 604 and the newly adapted DID instance document 605. Referring to FIG. 6, if it is assumed that the “TargetChoice” is a “ColorDepth” and designated as the “First” precedence, the attribute of the “reset” is “true”, so that the original DID instance document 601 is stored as the recently adapted DID instance document 602. A reordering process of designating the choice about “ColorDepth” of the recently adapted DID instance document 602 (which is the same as the original DID instance document) as the “First” precedence is carried out to create the newly adapted DID instance document 605 in which the “ColorDepth” is placed at the top of the document.

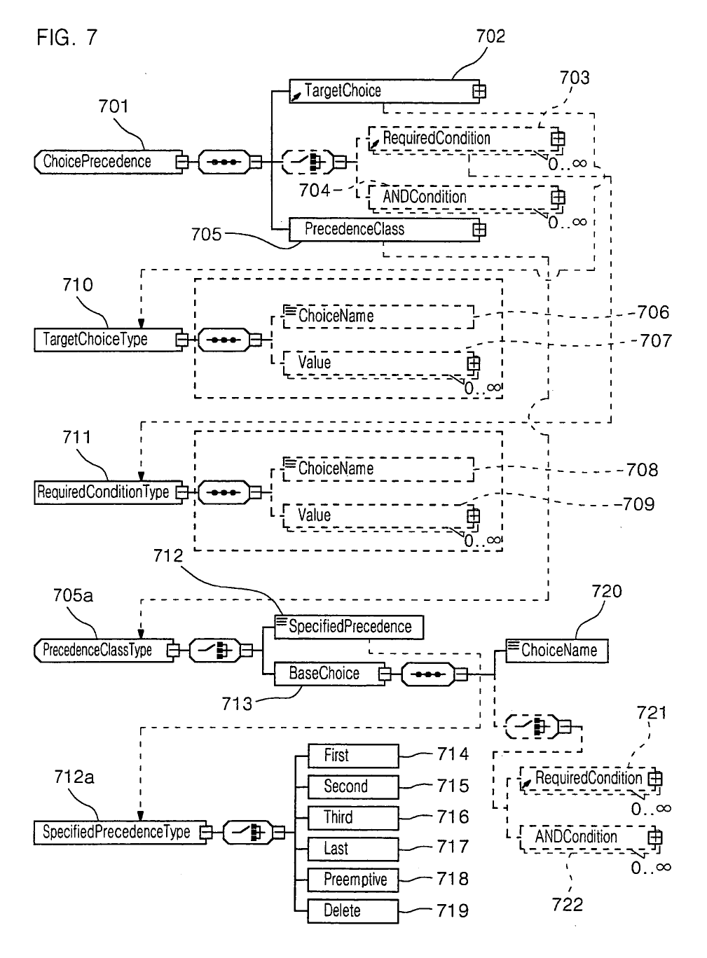

FIG. 7 illustrates the “ChoicePrecedence” descriptor for the DID instance document adaptation described above. According to the “ChoicePrecedence” descriptor, the precedence (that is, the configuration order) can be described to each choice generated in the DID instance document by various environment descriptors, so that the user is made to concentrate on an important decision. Additionally, the precedence of the configuration procedure with respect to the above-described environment descriptors can be modified.

The “ChoicePrecedence” descriptor 701 is defined by the “TargetChoice” 702, the “RequiredCondition” 703 of the “TargetChoice”, the “ANDCondition” 704 and the “PrecedenceClass” 705. In the present invention, the “TargetChoice” and the condition for selecting the “TargetChoice” are described so as to define the method of modifying the DID instance document. The “PrecedenceClass” declaring the target “ChoicePrecedence” is described. Here, the condition of the “TargetChoice” is described according to two types. One is to combine the choices for the condition with OR operation, the other is to combine them with AND operation.

The “TargetChoice” 702 is described by a “TargetChoiceType” 710, which is defined by a “ChoiceName” (that is, an environment variable such as a screen size) 706 and a corresponding “Value” 707 such as 640*480. The “RequiredCondition” 703 is described by a “RequiredConditionType” 711, which is defined a “ChoiceName” 708 and a corresponding “Value” 709.

Additionally, the “PrecedenceClass” 705 is described by a “PrecedenceClassType” 705a, which is defined a “SpecifiedPrecedence” 712 and a “BaseChoice” 713. The “SpecifiedPrecedence” 712 is described by a “SpecifiedPrecedenceType” 712a.

In the “SpecifiedPrecedenceType” 712a, an absolute precedence includes a “First” precedence 714, a “Second” precedence 715, a “Third” precedence 716, a “Last” precedence 717, a “Preemptive” precedence 718, and a “Delete” precedence 719. For example, if a choice of an environment variable (screen size) is set to the “First” precedence, it means that a choice of the screen size is first used in the configuration and then the “Second” and “Third” precedence is sequentially processed. The “Last” precedence is considered finally among the choices that are under consideration. The “Preemptive” precedence excludes the previously considered choices from the consideration and performs the configuration process while considering only the choice designated as the preemptive. The “Delete” precedence deletes the designated choice and performs the configuration process.

The “BaseChoice” 713 is a relative method used to designate the precedence of the choice for the digital item configuration in the DID instance document. According to the “BaseChoice” 713, the “BaseChoice” is designated and the precedence is set before or over the “BaseChoice”, that is, lower or higher than the “BaseChoice” by one degree (an example of the used attribute: “before”). For example, if the file format is the “BaseChoice” and “before=true” in the screen size, the DID adaptation is performed to allow the screen size to precede the file format without regard to an absolute precedence of the file format (here, the absolute precedence can be one of the first, second, etc.). As a result, the newly adapted DID instance document in which the screen size is placed in front of the file format is generated.

The “BaseChoice” 713 provides a corresponding “ChoiceName” 720. If there are the conditions in the choice, the “BaseChoice” 713 should describe the conditions 721 and 722. For example, it means that a choice of a screen size whose file format is “jpeg” and a choice of a screen size whose file format is “gif” can be processed with separate precedence.

As described above, the present invention provides the adaptation method of the DID instance document using the user precedence of the choices. The adaptation method of the present invention adapts the configuration procedure for the digital item adaptation, so that the multimedia contents can be adaptively modified according to user environment and user preference. Accordingly, high-level multimedia contents enough to satisfy the users can be provided through the appropriate adaptation to various users who are under various environments and in dynamically changing usage environment.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. In a description of multimedia contents based on usage environment descriptor and user preference descriptor of the multimedia contents, an adaptation method of generating a digital item declaration document, comprising:
applying a “ChoicePrecedence” to an input DID instance document;
modifying a corresponding “ChoicePrecedence” of the input DID instance document in an order designated in the “ChoicePrecedence”; and
generating a rearranged DID instance document.

2. The adaptation method of claim 1, wherein a process of inserting a DIAinDID descriptor into the DID instance document is preceded so as to make it possible to modify the input DID instance document adaptably, wherein the DIAinDID represents a corresponding choice.

3. The adaptation method of claim 2, wherein the DIAinDID descriptor includes a “TargetChoice” and a target choice condition.

4. The adaptation method of claim 1, wherein the DID instance document is an original DID instance document.

5. The adaptation method of claim 1, wherein the DID instance document is a recently adapted DID instance document obtained by modification just before adaptation.

6. The adaptation method of claim 1, wherein the DID instance document is a newly adapted DID instance document generated by a current adaptive modification.

7. The adaptation method of claim 1, wherein the “ChoicePrecedence” applies a “SpecifiedPrecedence”.

8. The adaptation method of claim 1, wherein the “ChoicePrecedence” applies a “BaseChoice”.

9. The adaptation method of claim 1, wherein the “ChoicePrecedence” is designated as an absolute precedence.

10. The adaptation method of claim 1, wherein the “ChoicePrecedence” is designated as one of a “First” precedence, a “Second” precedence, a “Third” precedence and a “Last” precedence.

11. The adaptation method of claim 1, wherein the “ChoicePrecedence” includes a “Preemptive” excluding previously considered choices from the consideration and performing a configuration process while considering only designated choice.

12. The adaptation method of claim 1, wherein the “ChoicePrecedence” includes a “Delete” precedence deleting a designated choice and performing a configuration process.

13. The adaptation method of claim 1, wherein the “ChoicePrecedence” is a relative precedence and designates higher or lower than a “BaseChoice”.

14. The adaptation method of claim 1, wherein the DID instance document is generated by using an attribute of “reset” for using an original DID instance document as an adapted DID instance document just before in case the “ChoicePrecedence” is applied to generate the DID instance document.

15. The adaptation method of claim 1, wherein the DID instance document is generated by using an attribute of “reorder” for referring to choice, which does not exist in an adapted DID instance document just before, in an original DID instance document in case the “ChoicePrecedence” is applied to generate the DID instance document.

16. The adaptation method of claim 1, wherein the DID instance document is generated by using an attribute of “before” to represent whether to designate higher or lower precedence than a “BaseChoice” in case the “ChoicePrecedence” is applied to generate the DID instance document.

17. In a description of multimedia contents based on usage environment descriptor and user preference descriptor of the multimedia contents, a method of generating a “ChoicePrecedence” descriptor of a digital item, comprising:
describing a “TargetChoice” of the digital item, a condition if necessary, and a “ChoicePrecedenceClass”; and
describing a “SpecifiedPrecedence” or a “BaseChoice” to the “ChoicePrecedenceClass”.

18. The method of claim 17, wherein the “ChoicePrecedenceClass” includes a “First” precedence meaning an absolute precedence of a corresponding choice, a “Second” precedence, a “Third” precedence, a “Last” precedence, a “Preemptive” precedence, and a “Delete” precedence.

19. The method of claim 17, wherein the “ChoicePrecedence” descriptor includes an attribute of “reset” for using an original DID instance document as a recently adapted DID instance document, an attribute of “reorder” for referring to choice, which does not exist in an adapted DID instance document just before, in an original DID instance document, and an attribute of “before” for representing whether to designate higher or lower precedence than a “BaseChoice”.
